(19) United States
(12) Patent Application Publication
(10) Pub. No.: US 2006/0126286 A1
(43) Pub. Date: Jun. 15, 2006

(54) Mouse and portable computer with the same

(75) Inventors: Hyung-Jun Kim, Suwon-si (KR); Sung-Jin Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/272,086

(22) Filed: Nov. 14, 2005

(30) Foreign Application Priority Data
Dec. 10, 2004 (KR) 2004-0104137

(51) Int. Cl. G06F 1/16

(52) U.S. Cl. 361/683

(57) ABSTRACT

A mouse is provided including a casing positionable within a card slot that is provided in a computer main body and used for mounting an external card to the computer main body. At least one operation button is provided on the casing.

### CROSS-REFERENCE TO RELATED APPLICATIONS

This application claims the benefit of Korean Patent Application No. 2004-0104137, filed on Dec. 10, 2004, the entire disclosure of which is hereby incorporated by reference.

### BACKGROUND OF THE INVENTION

1. Field of the Invention

The present invention relates to a mouse and a portable computer having the same. More particularly, the present invention relates to a mouse which is configured for positioning within a card slot arranged on the portable computer.

2. Description of the Related Art

In general, a portable computer comprises a computer main body mounted with a central processing unit (CPU), a graphic chip, and a display which displays a picture based on a video signal received from the computer main body. Portable computers include various computers such as a laptop computer, a notebook computer, and a palmtop computer, all of which are portable. Portable computers tend to be slimmer in outer appearance to improve portability and convenient manipulation.

For convenience purposes, many users employ a separate mouse in the portable computer. The separate mouse facilitates convenient manipulation; however, carrying the separate mouse may be burdensome.

A portable computer capable of accommodating a mouse has been disclosed in Korean Utility Model No. 341490, the entire disclosure of which is hereby incorporated by reference. This conventional portable computer comprises a mouse accommodating part provided in the computer main body to accommodate an mouse. Thus, a user can take the mouse out of the portable computer as necessary.

However, one drawback of the conventional portable computer is that the mouse accommodating part increases the size of the computer main body.

Accordingly, there is a need for an improved portable computer including a mouse configured for positioning within a card slot provided in the portable computer which also minimizes the size of the device.

### SUMMARY OF THE INVENTION

An aspect of the present invention is to address at least the above problems and/or disadvantages and to provide at least the advantages described below. Accordingly, an aspect of the present invention is to provide a mouse and a portable computer with the same, in which the mouse has an improved structure for accommodating the mouse in a card slot provided in the portable computer, thereby facilitating portability and minimizing the size of the device.

The foregoing and/or other aspects of the present invention are also achieved by providing a mouse comprising a casing positionable within a card slot that is provided in a computer main body and used for mounting an external card to the computer main body. At least one operation button provided on the casing.

According to an aspect of the present invention, the mouse further comprises a grip unit extractable from and retractable in the casing.

According to an aspect of the present invention, the grip unit comprises a grip rotatably coupled to the casing and a grip supporting portion to support the grip protruding from the casing.

According to an aspect of the present invention, the grip unit further comprises a grip accommodating portion formed on the casing which accommodates the grip. A grip base is placed inside the casing and rotatably supports the grip.

According to an aspect of the present invention, the mouse further comprises a connection port provided in the casing and connected to a connector of the card slot when the mouse is inserted in the card slot. A battery may be charged with power supplied through the connection port.

According to an aspect of the present invention, the mouse is turned off and the battery starts to charge when the connection port is connected with the connector. The mouse is turned on when the connection port is disconnected from the connector.

According to an aspect of the present invention, the mouse further comprises a wireless communication part to wirelessly communicate with the computer main body.

According to an aspect of the present invention, the card slot may support one of PCMCIA and PCI-Express.

The foregoing and/or other aspects of the present invention are also achieved by providing a portable computer comprising a computer main body which comprises at least one card slot provided in the computer main body. A mouse comprises a casing positionable within the card slot and at least one operation button is provided on the casing.

According to an aspect of the present invention, the portable computer may further comprises a grip unit extractable from and retractable in the casing.

According to an aspect of the present invention, the grip unit comprises a grip rotatably coupled to the casing and a grip supporting portion to support the grip protruding from the casing.

According to an aspect of the present invention, the grip unit further comprises a grip accommodating portion formed on the casing to accommodate the grip. A grip base is placed inside the casing and rotatably supports the grip.

According to an aspect of the present invention, the portable computer further comprises a connection port provided in the casing and connected to a connector of the card slot when the mouse is inserted in the card slot. A battery may be charged with power supplied through the connection port.

According to an aspect of the present invention, the mouse is turned off and the battery starts to be charged when the connection port is connected with the connector. The mouse is turned on when the connection port is disconnected from the connector.

According to an aspect of the present invention, the portable computer further comprises a wireless communication part to wirelessly communicate with the computer main body.

According to an aspect of the present invention, the card slot supports one of PCMCIA and PCI-Express.

Other objects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a perspective view of a mouse according to an embodiment of the present invention;

FIG. 2 is an exploded perspective view of a gripping unit provided in the mouse according to an embodiment of the present invention;

FIGS. 3 and 4 are perspective views illustrating an operation of the gripping unit provided in the mouse according to an embodiment of the present invention;

FIG. 5 is a schematic block diagram of the mouse according to an embodiment of the present invention; and

FIG. 6 is a perspective view illustrating the mouse and a portable computer according to an embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

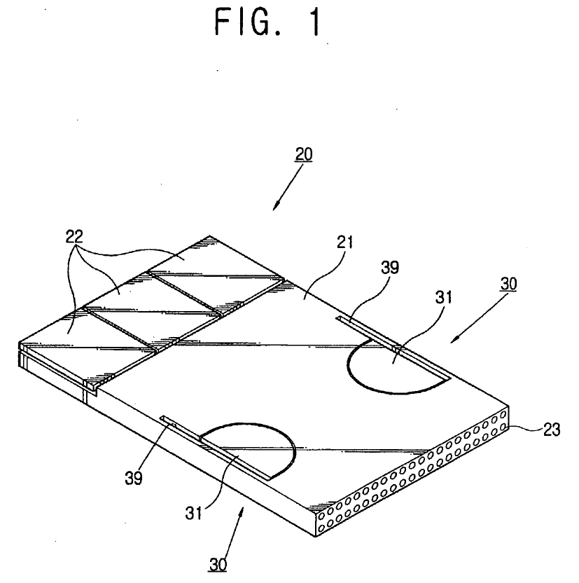

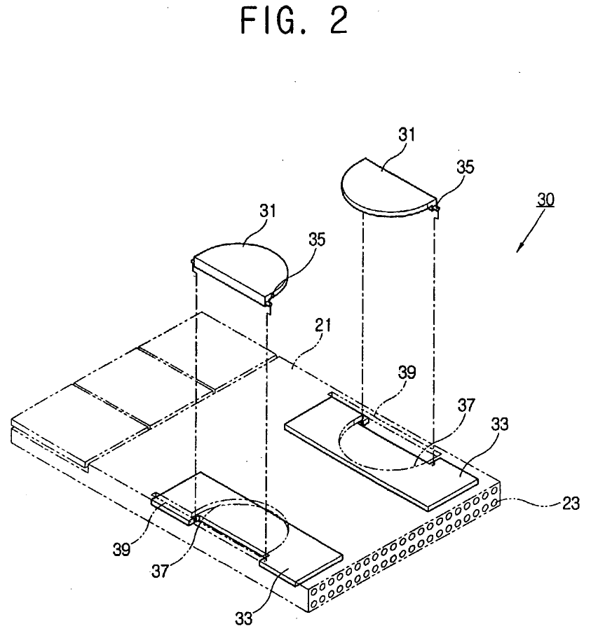

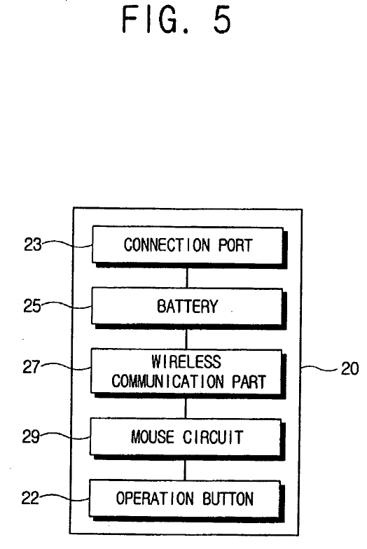

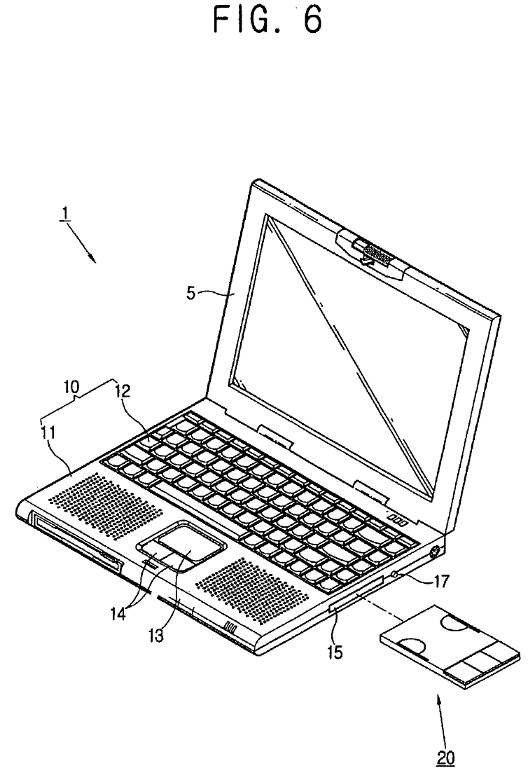

FIGS. 1 through 5 illustrate a mouse according to an embodiment of the present invention, and FIG. 6 illustrates a portable computer according to an embodiment of the present invention. As shown therein, a mouse 20 according to an embodiment of the present invention comprises a casing 21 capable of being accommodated in a card slot 15 (refer to FIG. 6) of a computer main body 10. At least one operation button 22 is provided on the casing 21. The mouse 20 further comprises a gripping unit 30 extractable from and retractable in the casing 21. Further, the mouse 20 comprises a connection port 23 provided in a casing 21 and connected to a connector (not shown) internally provided in the card slot 15 when inserted in the card slot 15. A battery 25 is provided which is charged with power supplied through the connection port 23. Further, the mouse 20 comprises a wireless communication part 27 to wirelessly communicate the mouse 20 with the computer main body 10.

The casing 21 has a rectangular shape corresponding to the card slot 15. However, the casing 21 is not limited to the rectangular shape and other suitable arrangements may be used as long as the mouse 20 can be inserted and accommodated in the card slot 15.

The card slot 15 is exposed to the outside of the computer main body 10 (refer to FIG. 6), so that an external card can be selectively inserted in and mounted to the card slot 15. Preferably, the card slot 15 is supported by one of a personal computer memory card international association (PCMCIA) and, peripheral component interconnect express (PCI-Express), so that various external cards such as memory cards and network modem cards can be mounted to the card slot 15. However, the card slot 15 is not limited to the PCMCIA and the PCI-Express. Alternatively, the card slot 15 may support various other suitable external cards.

Operation buttons 22 are arranged on a first side of the casing 21 and allows a user to control a display element such as a cursor or point displayed on a display 5 (refer to FIG. 6). According to an exemplary embodiment of the present invention, three operation buttons 22 are provided; however, alternatively, two or less operation buttons, or four or more operation buttons may be provided. The operation buttons 22 are connected to components such as a mouse circuit 29 and the wireless communication part 27, thereby transmitting a control signal to the computer main body 10.

The connection port 23 is arranged on a second side of the casing 21, opposite to the control button 22. For example, the connection port 23 is formed to receive a plurality of pins provided in the connector (not shown) which is provided in the card slot 15. Alternatively, the connection port 23 may be formed to have various suitable shapes corresponding to the connector. When the connection port 23 is connected to the connector, the mouse 20 is turned off. On the other hand, when the connection port 23 is disconnected from the connector, the mouse 20 is turned on. Alternatively, a separate power switch may be provided to turn the mouse 20 on/off. Further, the mouse 20 may use other suitable methods to turn on/off. For example, the mouse 20 may turn off automatically when not used for a predetermined period of time.

The battery 25 is located inside the casing 21, and supplies power for operating the mouse 20. The battery 25 preferably includes a rechargeable battery. That is, the battery 25 is charged with power supplied through the connection port 23 when the connection port 23 is connected to the connector. Alternatively, the battery 25 may be exchangeable with a new battery when the battery 25 reaches the end of the battery lifecycle.

The wireless communication part 27 is placed inside the casing 21. Correspondingly, the computer main body 10 comprises a communication unit to communicate with the wireless communication part 27 of the mouse 10. The wireless communication part 27 receives signals corresponding to position shifts of the casing 21 and operational states of the operation button 22 from the mouse circuit 29. The signals are wirelessly transmitted to the computer main body 10. According to an exemplary embodiment of the present invention, the wireless communication part 27 is supported by BLUETOOTH™ standard technology. However, the wireless communication part 27 is not limited to the BLUETOOTH™ standard. Alternatively, the wireless communication part 27 may be supported by any other suitable wireless network standards.

The gripping unit 30 protrudes outward from the casing 21 while being used by a user. Thus, a user may easily grip the mouse 20. Further, the gripping unit 30 can be folded while being accommodated in the card slot 15. The gripping unit 30 comprises a grip 31 rotatably coupled to the casing 21. A grip supporting portion 39 supports the grip 31 as it protrudes from the casing 21. Further, the gripping unit 30 comprises a grip accommodating portion 37 formed on the casing 21 to accommodate the grip 31, and a grip base 33 provided in the casing 21 to rotatably support the grip 31. The grip 31 forms a pair and is rotatably coupled to opposite sides of the casing 21. However, a single grip, or three or more grips may also be provided. Further, the grip 31 has a semicircular shape to facilitate gripping by the user. However, the grip 31 is not limited to the semicircular shape. Alternatively, the grip 31 may have various shapes such as an elliptical shape or a polygonal shape.

The grip accommodating portion 37 is formed by cutting a portion of a top surface of the casing 21, thereby accommodating the grip 31 therein. Thus, the mouse 20 may be smoothly inserted in the card slot 15 without interference from the grip 31.

The grip base 33 is rotatably coupled to the grip 31 via the grip accommodating portion 37, thereby allowing the grip 31 to stand on the surface of the casing 21. The grip base 33 is rotatably coupled to the grip 31 by a hinge shaft 35. Further, the grip base 33 slides together with the grip 31 within the grip supporting portion 39.

The grip supporting portion 39 is formed as an elongated hole in opposite sides of the top surface of the casing 21, and accommodates and supports a lower portion of the grip 31. Thus, the grip 31 can be maintained standing on the top surface of the casing 21 while being inserted in the grip supporting portion 39.

As shown in FIG. 6, a portable computer 1 according to an embodiment of the present invention comprises the computer main body 10, the display 5 coupled to the computer main body 10, at least one card slot 15 formed in the computer main body 10 for accommodating the external card therein, and the mouse 20 capable of being accommodated in the card slot 15.

The computer main body 10 comprises a cover 11 forming an outer surface. A plurality of hardware components such as a main board (not shown) are provided inside the cover 11 and mounted with a CPU, and a random access memory (RAM). A keyboard 12 is provided for inputting data, a touch pad 13, and a selection button 14 are placed on a top surface of the cover 11 to allow a user to control a display element such as a cursor or point on the display 5.

Here, the card slot 15 and the mouse 20 have the same configuration as described above, so duplicative descriptions thereof will be omitted for clarity and conciseness.

Thus, a user employs the touch pad 13 and the selection button 14 provided in the computer main body 10 of the portable computer 1 or employs the mouse 20 for controlling the point displayed on the display 5.

With this configuration, a user can take the mouse 20 out of the portable computer 1 and insert the mouse 20 into the portable computer 1 as follows.

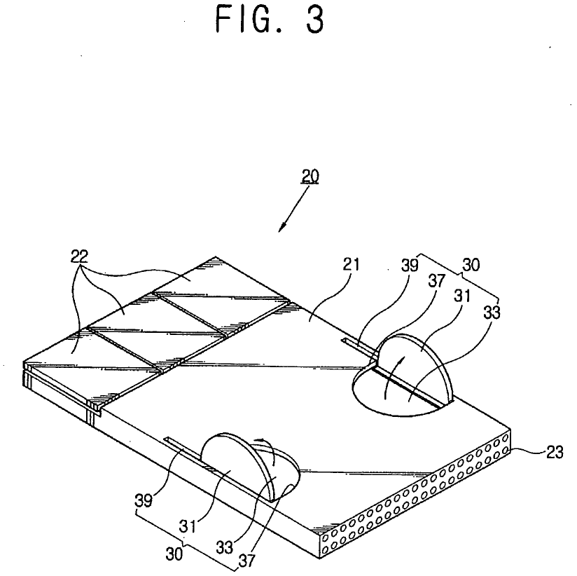

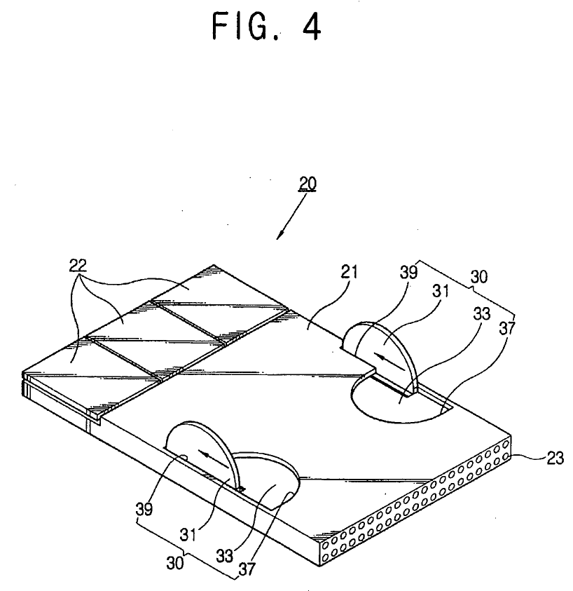

As shown in FIG. 1, the mouse 20 is extracted from the card slot 15 of the portable computer 1. When the mouse 20 is disconnected from the card slot 15, the mouse 20 is turned on. Then, the pair of grips 31 provided in the casing 21 of the mouse 20 rotate to stand on the surface of the casing 21 (refer to FIG. 3). Then, the grip 31 slides toward the grip supporting portion 39, thereby maintaining the grip 31 in a standing position on-the casing 21 (refer to FIG. 4). Thus, a user can manipulate the mouse 20, so that the signal generated by operating the mouse 20 is transmitted to the computer main body 10 through the wireless communication part 27, thereby controlling the computer main body 10. At this time, the grip unit 30 allows a user to use the mouse 20.

On the other hand, the grip 31 is accommodated in the grip accommodating portion 37 in a reverse order. Then, as shown in FIG. 6, the mouse 20 can be inserted in the card slot 15 of the computer main body 10. When the connection port 23 of the mouse 20 is connected to the connector provided inside the card slot 15, the mouse 20 is turned off, and the battery 25 is charged.

According to an embodiment of the present invention, the mouse 20 is extracted from the card slot 15 by pushing an extracting button 17 placed adjacent to the card slot 15.

According to an embodiment of the present invention, the mouse is accommodated in the card slot provided in the computer main body, thereby easily accommodating the mouse in the computer main body. Further, the mouse is accommodated in the card slot so that a separate mouse accommodating part is not needed, thereby minimizing the size of the device and improving portability.

While the invention has been shown and described with reference to certain embodiments thereof, it will be understood by those skilled in the art that various changes in form and details may be made therein without departing from the spirit and scope of the invention as defined by the appended claims.

What is claimed is:

1. A mouse comprising:
a casing positionable within a card slot that is provided on a computer main body to mount the casing to the computer main body; and
at least one operation button provided on the casing.

2. The mouse according to claim 1, further comprising a gripping unit extractable from and retractable in the casing.

3. The mouse according to claim 2, wherein the gripping unit comprises:
a grip rotatably coupled to the casing; and
a grip supporting portion to support the grip protruding from the casing.

4. The mouse according to claim 3, wherein the grip unit further comprises:
a grip accommodating portion formed on the casing and accommodating the grip; and
a grip base placed inside the casing and rotatably supporting the grip.

5. The mouse according to claim 1, further comprising:
a connection port provided in the casing which connects to a connector of the card slot when the mouse is inserted in the card slot; and
a battery configured to charge with power supplied through the connection port.

6. The mouse according to claim 5, wherein the mouse is turned off and the battery starts to be charged when the connection port is connected with the connector, and the mouse is turned on when the connection port is disconnected from the connector.

7. The mouse according to claim 1, further comprising a wireless communication part to wirelessly communicate with the computer main body.

8. The mouse according to claim 1, wherein the card slot supports one of PCMCIA and PCI-Express.

9. A portable computer comprising a computer main body, comprising:
at least one card slot provided on the computer main body; and
a mouse capable positionable within the card slot, wherein the mouse comprises a casing to be accommodated in the card slot; and at least one operation button provided on the casing.

10. The portable computer according to claim 9, further comprising a gripping unit extractable from and retractable in the casing.

11. The portable computer according to claim 10, wherein the gripping unit comprises:
a grip rotatably coupled to the casing; and
a grip supporting portion to support the grip protruding from the casing.

12. The portable computer according to claim 11, wherein the gripping unit further comprises:
a grip accommodating portion formed on the casing and accommodating the grip; and
a grip base placed inside the casing to rotatably support the grip.

13. The portable computer according to claim 9, further comprising:
a connection port provided in the casing and connected to a connector of the card slot when the mouse is inserted in the card slot; and
a battery configured to charge with power supplied through the connection port.

14. The portable computer according to claim 13, wherein the mouse is turned off and the battery starts to charge when the connection port is connected with the connector, and the mouse is turned on when the connection port is disconnected from the connector.

15. The portable computer according to claim 9, further comprising a wireless communication part to wirelessly communicate with the computer main body.

16. The portable computer according to claim 9, wherein the card slot supports one of PCMCIA and PCI-Express.

17. A portable computer comprising a computer main body, comprising:
at least one card slot provided on the computer main body configured to mount an external card therein; and
a mouse including a casing positionable within the card slot, the mouse including a gripping unit extractable from and retractable in the casing; and
a connection port provided on the casing connects to a connector of the card slot when the mouse is inserted in the card slot.
